(19) United States
(12) Patent Application Publication
(10) Pub. No.: US 2007/0233552 A1
(43) Pub. Date: Oct. 4, 2007

(54) Method for soliciting and receiving voter feedback

(76) Inventor: Frank S. Maggio, St.Petersburg, FL (US)

Correspondence Address: KING & SPALDING LLP, 1180 PEACHTREE STREET, ATLANTA, GA, 30309-3521, US

(21) Appl. No.: 11/712,861

(22) Filed: Mar. 1, 2007

Related U.S. Application Data
(60) Provisional application No. 60/778,640, filed on Mar. 1, 2006.

(51) Int. Cl. G06F 11/00

(52) U.S. Cl. 705/12

(57) ABSTRACT

A method for soliciting and receiving voter feedback can comprise requesting and receiving comments, feedback, or positions from voting constituents and providing that information to elected officials for review in connection with deciding how to vote. The invention supports a method for notifying constituents about live discussions and debates on issues, during which constituents and elected officials become better educated. Steps in the method can comprise soliciting input from the constituents about an issue and weighting input according to one or more rules. Input from constituents demonstrating that they are informed or from constituents directly impacted by an issue can be weighed more heavily than input from other constituents. A database stores a record of input from each constituent so that elected officials can review opinion patterns of each constituent. Meanwhile, constituents can access a database of the voting records of elected officials.

### CROSS REFERENCE TO RELATED APPLICATIONS

This application claims priority to U.S. Provisional Patent Application Ser. No. 60/778,640, filed Mar. 1, 2006, entitled “Method and System for Providing Broadband Access, HDTV, and Broadband-Enabled Services,” the entire contents of which are hereby incorporated herein by reference.

This application is related to U.S. patent application Ser. No. 11/603,795, entitled “Method and System for Providing Broadband Access, HDTV, and Broadband-Enabled Services” and filed on Nov. 22, 2006, the entire contents of which are hereby incorporated herein by reference.

### FIELD OF THE INVENTION

The present invention relates to a computer-implemented method for providing real-time feedback to elected officials. In particular, the invention provides methods for soliciting and receiving feedback from voters or potential voters on issues to be decided by elected officials or other public or quasi-public entities.

### BACKGROUND OF THE INVENTION

While a democratic republic may be one of the most free and representative forms of government, several drawbacks can result. For instance, while a person must be elected by voters making up the electorate, the only time the elected officials appear to be responsive to their voters is during the period immediately preceding an election. Furthermore, even if an elected official wants to hear how his constituents feel about an issue, it is often difficult to obtain a broad range of views because the elected official is limited in the amount of time and the area that he can cover to meet his constituents. In the past, in order to overcome these problems elected officials have held town hall meetings or conducted surveys of their constituents about the issues.

Unfortunately town hall meetings often have a limited scope and do not allow for views on opposing sides to be exchanged in a manner that educates both the constituents and the elected official. Instead, town hall meetings often turn into “gripe” sessions where only the most volatile topics are discussed and the views expressed are limited to parties on opposing sides of an issue screaming at one another. In addition, the timing or location of the town hall meeting may preclude some constituents from attending.

While a survey can solicit input from a broader range of constituents, conventional surveys likewise suffer from drawbacks. A relatively narrow set of topics or issues may appear in such a survey. Typical surveys lack sufficient flexibility to solicit input regarding issues that constituents deem important. Rather, rather most surveys are oriented towards topics of interest to the surveyor, who may have a bias. Moreover, surveys generally fail to educate constituents with any significant depth, beyond merely acknowledging that an issue exists.

Another conventional method of receiving views from constituents on an issue entails holding a public forum prior to voting on an issue. The public forum allows people to stand before the elective body and present their views on the issue. However, the public forum has several drawbacks as well. First, because the time period of the public forum is constrained, only a limited number of people are able to speak. In addition, each speaker is often limited to a specific amount of time, which may or may not allow speakers to fully explain their views or educate the elective body. Furthermore, there is generally no way to determine if the person speaking is a registered voter, is registered to vote in the area being represented by the elective body, or whether the person would significantly be impacted by the issue being discussed. Furthermore, in many cases, a disproportionate amount of people attending the public forum are those against an issue. Meanwhile, many of those supporting the issue fail to attend and express their views. Thus, the views being expressed during a public forum are often skewed significantly in one direction. Consequently, such forums often fail to educate the elected officials about the true views of the broad electorate. Moreover, observers, attendees, and media professionals may be swept into a negative wave about an issue that is in fact based more on perception than on fact.

Accordingly, there is a need in the art for a method by which an elected official can solicit views from a broad spectrum of constituents. The need extends to assessing how the constituents would vote on an issue prior to the elected official casting a vote on behalf of the constituents. In addition, there is a need in the art for a method by which constituents are able to better educate the elected officials about an issue. Furthermore, there is a need in the art for a method by which constituents are able to review the voting and attendance records of elected officials as compared to the positions taken by the official's constituents. These and other needs are satisfied by the current invention.

### SUMMARY OF THE INVENTION

The present invention supports improved interaction between an electorate and an elected official. The elected official can receive input from constituents, whether they be registered voters or not, (hereinafter “constituents”) about pending government decisions. Each constituent's input can be weighted according to rules that pertain to a level of constituent knowledge of pending decisions. Software and/or services, termed a MuniMax CiviConnect system (hereinafter “CiviConnect system” or “system”), can provide constituents with access to their elected officials and can provide officials with access to their constituents. The CiviConnect system comprises or links to a server and database. Via the server and database, an elected or appointed official or other public official having voting authority over issues (collectively “elected official” or “official”) can readily poll citizens regarding their opinions on important matters.

The official can also add “informed screening” content that requires a citizen to read background materials and to verify comprehension of a matter before being cleared to cast a vote. Alternatively, votes submitted without verification can be weighed less than votes submitted with the verification. For example, a vote from an informed citizen could be equivalent to two, three, five, ten, twenty, or one hundred, or any other number, of uninformed or unverified votes. The weighting can be implemented in a computer executed process based on software, for example.

The CiviConnect system can help a government official collect well-written opinions on both sides of a matter or issue under consideration or debate. Those opinions can be posted on a public website of the CiviConnect system, for example. Thus, citizens can view, over the MuniMax network, both sides of the issue before casting an electronic vote. A citizen posting an opinion can identify herself or alternatively can elect to remain anonymous. Further, elected officials can weigh in with their own opinions, with the website showing the officials' opinions or positions.

The CiviConnect system can include a website that can categorize matters under consideration according to issues. Exemplary issues can include financial, property rights, human rights, etc. Over time, by weighing each issue and then recording the vote or response of the constituent, the constituents and elected official both can learn about the dispositions or leanings of one another. That is, the website can track each constituent's online votes and/or opinions for review by the official, the constituent, and/or other constituents. In this manner, constituents, officials, and/or other interested parties can track trends of individual constituents, groups of constituents, and/or elected officials.

The CiviConnect system can track how often the constituent is on the winning or losing side of a decision. An elected official can elect to use the database to poll specific, selected, or individual constituents based on historical voting patterns. Such polls can provide opinions or assistance in formulating the elected official's opinion. In addition, an official can develop a “jury” method of voting by specifying how heavily he wishes to rely on certain core constituents, or alternatively on his total constituents, to sway his individual votes. That is, the elected official can identify a group of constituents whose opinions he wishes to track, to consider, or to heed.

The system can allow citizens to see how elected officials vote and how often officials attend hearings and place votes. This information can be available to the press, as well as all constituents. The CiviConnect system can also support chat functions so that constituents can have access to a full-time forum for expressing ideas, improvement proposals, and the like. The CiviConnect software can promote, elevate, and/or increase the efficiency of the democratic process, with a focus on adding an educational element. The system's software can allow officials or citizens to take polls, which can be privately or publicly accessed. With the “weighting” feature, the system can determine patterns that indicate when a matter has traction, is gaining popularity, or is changing the minds of voters. For example, the CiviConnect system might reveal that constituents who are fiscally conservative voters are leaning in favor of an amendment or ordinance that one would otherwise think that conservatives would vote against. Citizens can use an interactive or reactive remote control (hereinafter the “remote control”) for interacting with the CiviConnect system. Moreover, citizens can access real-time or prerecorded broadcasts relevant to an issue under consideration, for example in the form of programming available on the C-SPAN network or an educational network.

In one aspect, the present invention provides a method for soliciting feedback from at least one constituent. An elected official can employ the system to solicit a response from one or more constituents, such as registered voters, about an issue that is being discussed or debated, or for which an elected official has voting authority. Additional information, such as more detailed information or explanations about each side of an issue, can be provided for selection by each of the constituents at a web portal of the system. The system can determine if any of the constituents reviewed the additional information that was provided. Responses, such as votes, on the issues can be received from one or more of the constituents at the web portal. After receiving a constituent's response, the response can be weighted based on whether the constituent reviewed the additional information provided at the web portal.

For another aspect of the present invention, an elected official can solicit feedback from constituents, such as registered voters, by soliciting a response from one or more constituents about an issue. One or more parameters can be selected, for example by an elected official, to determine if responses from any of the constituents should be given special consideration. Responses, such as votes, to the issue can be received from constituents at the web portal. For instance, the responses can be received from the constituents by way of keystroke data from a remote control. After receiving a constituent's response, the response can be weighted based on whether the constituent has been selected for special consideration by matching the selected parameters.

For yet another aspect of the present invention, an elected official can solicit feedback from constituents, such as registered voters, by employing the system to transmit a notification informing one or more constituents that a discussion about an issue is currently being broadcast on television or live video on an Internet-accessible device. The notification can be received by the constituents on an Internet-accessible device, such as a remote control, or a personal computer. The system can receive a response to the notification, such as comments or a vote regarding the issue, from the constituents that were notified through the Internet-accessible device. Upon receiving the responses at the web portal, the responses can be tallied and transmitted electronically to elected officials having voting authority over the issue.

For another aspect of the present invention, an elected official can solicit feedback from a group of constituents by providing one or more parameters, such as geographic or demographic information, to select the constituents from which the elected official wants to receive comments. Demographic information can include, but is not limited to, race, color, creed, age, sex, national origin, religion, sexual orientation, income level, educational level, disability status, occupation, location of employment, and location of residence. The system can receive the selected parameters through a web portal and conduct a search of a database of constituents to determine the constituents that match the selected parameters. A response can be solicited from the matching constituents by transmitting a request through the web portal or directly to an Internet-accessible device, such as a remote control having a video display. Responses to the issues highlighted in the solicitation can be received from the matching constituents through the web portal or by way of keystroke data from the remote control. The system can determine if the matching constituents satisfy a predetermined requirement, such as being an informed constituent or a registered voter. The system can then give responses from constituents satisfying the predetermined requirement a greater weight than the responses from constituents that do not match the requirement.

### BRIEF DESCRIPTION OF DRAWINGS

For a more complete understanding of the exemplary embodiments of the present invention and the advantages thereof, reference is now made to the following description in conjunction with the accompanying drawings in which:

FIG. 1 is a flowchart illustrating a process for presenting issues to constituents and receiving and recording constituent feedback in accordance with an exemplary embodiment of the present invention;

FIG. 2 is a flowchart illustrating a process for requesting and receiving constituent feedback on constituent issues in accordance with an exemplary embodiment of the present invention;

FIG. 3 is a flowchart illustrating a process for interactive response to televised community issues in accordance with an exemplary embodiment of the present invention;

FIG. 4 is a flowchart illustrating a process for retrieving and comparing voting records of an elected official to positions of his constituents in accordance with an exemplary embodiment of the present invention;

FIG. 5 is a flowchart illustrating a process for selecting a subset of constituents based on a set of parameters and weighing feedback from those constituents based on another set of parameters in accordance with an exemplary embodiment of the present invention;

FIG. 6 is a flowchart illustrating a process for searching a database for constituents with common positions on issues in accordance with an exemplary embodiment of the present invention; and

FIG. 7 is a flowchart illustrating a process for receiving real-time feedback from constituents viewing discussion on an issue in accordance with an exemplary embodiment of the present invention.

### DETAILED DESCRIPTION OF THE EXEMPLARY EMBODIMENTS

The present invention provides improved interaction between an electorate and an elected official by supporting methods and systems for receiving on-line, Internet-accessible, and/or real-time feedback from constituents on issues that are presented before a public body, such as a legislature, county commission, city council, or similar body. In the form of a handheld device, a reactive remote control can be enhanced with MuniMax/WIMAX chips. The WIMAX chips provide the reactive remote with connectivity to the wireless digital network.

WIMAX, as will be appreciated by those skilled in the art, is a standards-based wireless technology that supports high-throughput broadband connections, often over long distances. Typical applications of WIMAX technology include “last mile” broadband access, cellular backhaul and hotspots, and providing businesses or enterprises with high-speed access.

Software and/or services in the CiviConnect system provide constituents with access to their elected officials and provide officials with access to their constituents. The CiviConnect system comprises or links to a server and database. Via the server and database, an elected or appointed official or other public official having voting authority over issues can readily poll citizens regarding their opinions on important matters. The CiviConnect system can also include a website that can categorize matters under consideration according to issues. Exemplary issues can include financial, property rights, human rights, etc. The website is also capable of tracking each constituent's online votes and/or opinions for review by the official, the constituent, and/or other constituents.

The official can also add “informed screening” content that requires a citizen to read background materials and weighs the constituent's response differently based on whether the background materials were comprehended by the constituent. The weighting can be implemented in a computer executed process based on software in the CiviConnect system. The CiviConnect system can help a government official collect well-written opinions on both sides of an issue and post those opinions on a web portal of the CiviConnect system. Furthermore, elected officials can weigh in with their own opinions, with the website showing the officials' opinions or positions.

The CiviConnect system can further track how often the constituent is on the winning or losing side of a decision. An elected official can elect to use the database to poll specific, selected, or individual constituents based on their historical voting patterns. Moreover, citizens can access real-time or prerecorded broadcasts relevant to an issue under consideration, for example in the form of programming available on the C-SPAN network or an educational network.

The system also includes a database for storing information about how elected officials vote, their attendance during meetings and debates on an issue, and how often they place votes. The CiviConnect system can also support chat functions so that constituents can have access to a full-time forum for expressing ideas, improvement proposals, and the like. The CiviConnect software can promote, elevate, and/or increase the efficiency of the democratic process, with a focus on adding an educational element. The system's software can allow officials or citizens to take polls, which can be privately or publicly accessed. With the “weighting” feature, the system can determine patterns that indicate when a matter has traction, is gaining popularity, or is changing the minds of voters. U.S. patent application Ser. No. 11/603,795, entitled “Method and System for Providing Broadband Access, HDTV, and Broadband-Enabled Services” and filed on Nov. 22, 2006, describes in greater detail the WIMAX and CiviConnect systems, the entire contents of which are hereby incorporated herein by reference.

Constituents can use an interactive or reactive remote control for interacting with the CiviConnect system. In one exemplary embodiment, the remote control provides direct network connectivity. Thus, in various exemplary embodiments, the remote control can function without a home base-station, a wi-fi base station, a repeater device, or some other intermediary or buffer between the remote control and the digital network. In other words, the remote control can send and receive signals to the TV and can send and receive signals over a wireless mesh network that carries digital TV signals. Moreover, the reactive or interactive remote control can comprise voice over Internet protocol (VoIP) functionality.

U.S. patent application Ser. No. 11/479,709, entitled “Method and System for Automatically Substituting Media Content” and filed on Jun. 30, 2006, describes various handheld devices, media systems, communication devices, remote controls, and media appliances that can be integrated with a MaxBox system. That is, the MaxBox system can provide any of the capabilities or functions for remote controls described in U.S. patent application Ser. No. 11/479,709, the entire contents of which are hereby incorporated herein by reference.

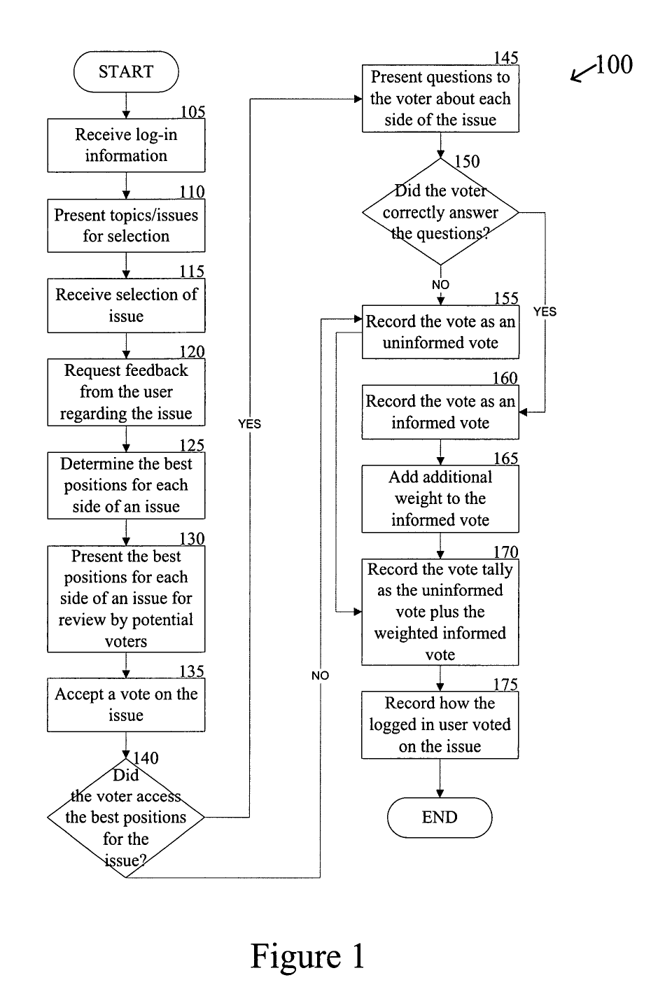

Exemplary embodiments of the invention can be more readily understood by reference to the accompanying figures. Referring now to the drawings, in which like numerals represent like elements throughout the several figures, aspects of the present invention will be described. FIGS. 1-7 are logical flowchart diagrams illustrating the exemplary methods for receiving on-line and real-time feedback from constituents on issues that are presented before a public body. FIG. 1 is a flowchart illustrating a process 100 for presenting issues to constituents and receiving and recording constituent feedback presented in accordance with an exemplary embodiment of the present invention. Now referring to FIG. 1, the exemplary method 100 begins at the START step and proceeds to step 105, where a voter or constituent provides log-in information to the system. While the present application describes the methods in relation to a voter or constituent for ease of reference, the steps could also be accomplished by any person having access to the system. In one exemplary embodiment, log-in and/or registration information needed to access the system can include a unique identification number, a portion of the constituent's social security number, a telephone number for the constituent, a voter identification number, the constituent's address or zip code, and/or other demographic information for the constituent. Demographic information can include, but is not limited to, race, color, creed, age, sex, national origin, religion, sexual orientation, income level, educational level, disability status, occupation, location of employment, and location of residence. The information necessary for registering or logging onto the system is meant to prevent a constituent from having more than one account on the system. In one exemplary embodiment, the voter identification number and social security number of the constituent are used by the system only to verify their registration information or their status as a registered voter and the social security number information and voter identification information is not tracked thereafter by the system.

In step 110, topics or issues relevant to the constituent are presented for selection. In one exemplary embodiment, the issues could be presented on the web page associated with the system. The relevance of topics or issues can be determined, for example, based on the constituent's address, the constituent's demographic information, or the constituent's place of employment. A selection of an issue for review is received from a constituent at the system in step 115. In step 120, the system presents information related to the selected issue and requests feedback from the constituent regarding the issue. In one exemplary embodiment, the feedback requested can include whether the constituent agrees or disagrees with the issue, reasons or arguments for or against the issue, or additional educational information that the constituent may have regarding the issue that has not yet been presented.

In step 125, the best positions, or arguments, for each side of an issue are determined. In one exemplary embodiment, the best positions are determined by the elected official or his staff based on their review of all or substantially all of the positions presented by viewing constituents, the elected official, or other third parties. In an alternative embodiment, the information presented to the constituent could be from one or more public or private information sources and not limited to information or arguments presented by other voters accessing the system. The best positions for each side of an issue are presented for review by constituents on the system in step 130. In step 135, a vote on the issue is accepted from the constituent on the system via the web portal or through keystroke data from the remote control. In step 140, an inquiry is conducted to determine if the constituent accessed the best positions for the issue. In one exemplary embodiment, the constituent could access the best positions for the issue by selecting a link included on the web page describing the issue. If the constituent accessed the best positions for the issue, the “YES” branch is followed to step 145, where the system presents questions to the voter about the best positions being presented to determine the constituent's comprehension of the best positions. On the other hand, if the voter did not access the best positions information, the “NO” branch is followed to step 155. In one exemplary embodiment, the questions could take the form of multiple choice, matching, or essay questions and can be presented on the same or subsequently linked web pages on the system. In an alternative embodiment, the questions could be related to one or more sources of information about the issue and not limited to a selection of best positions presented to the voter. In one exemplary embodiment, the purpose of the questions related to the best positions is to determine how educated the voter is about the issue and whether the voter was willing to review opposing views prior to making their voting selection.

In step 150, an inquiry is conducted to determine if the constituent correctly answered the questions related to the best positions. If the constituent did not answer the questions correctly, the “NO” branch is followed to step 155, where the constituent's vote is recorded as an “uninformed vote.” In one exemplary embodiment, the determination of whether a constituent correctly answered the questions could be based on whether they got all or a pre-selected percentage of the questions correct. Returning to step 150, if the constituent correctly answered the questions, the “YES” branch is followed to step 160, where the constituent's vote is recorded as an “informed vote.” Additional weight is added to the informed vote in step 165. In one exemplary embodiment, an informed vote could count twice as much as an uninformed vote; however, those of ordinary skill in the art will recognize that the amount of weight that is added to an informed vote is easily adjustable from one to infinity. In an alternative embodiment, the system could reduce the weight of an uninformed vote instead of adding weight to an informed vote to accomplish the same result. In another alternative embodiment, circumstances may arise where the uninformed vote and the informed vote are given the same weight.

In step 170, the system records the vote tally of the uninformed vote and the weighted informed vote. In one exemplary embodiment, the vote tally is presented to one or more elected officials having voting, advisory, or supervisory responsibility over the selected issue. The vote for the logged-in voter on the issue is recorded in a database on the system in step 175. In one exemplary embodiment, the logged-in voter can be given the option whether he wants his vote or positions recorded or “linked” to the voter. In an alternative embodiment, the system can provide an opt-out selection that allows the logged-in voter to remain anonymous. The process continues from step 175 to the END step.

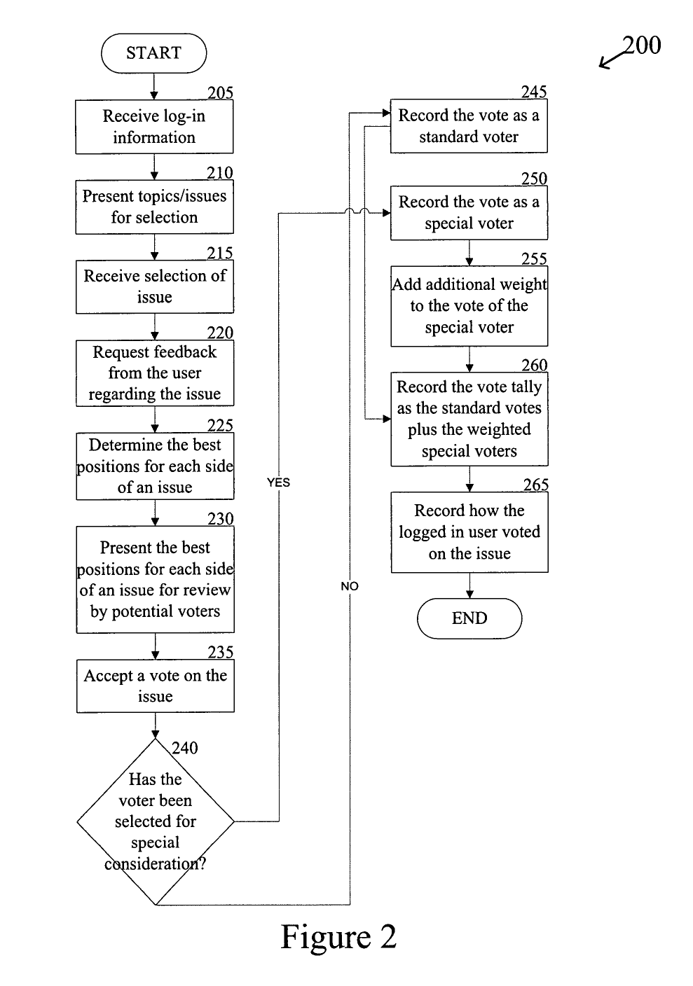

FIG. 2 is a logical flowchart diagram presented to illustrate the steps of an exemplary method 200 for requesting and receiving voter feedback on constituent issues, presented in accordance with an exemplary embodiment of the present invention. Now referring to FIG. 2, the exemplary method 200 begins at the START step and proceeds to step 205, where the system receives constituent log-in information as described hereinabove in FIG. 1. In step 210, topics or issues are presented to the constituent for selection. In one exemplary embodiment, the topics or issues are presented on a web page. In another exemplary embodiment, the system is accessed via a television and remote control and the topics and issues are presented on the television screen or personal computer capable of displaying video and television content. An issue is selected by the logged-in constituent in step 215.

In step 220, feedback is solicited from the constituent regarding the issue. In one exemplary embodiment, the feedback can be solicited by asking the constituent to respond to one or more questions related to the issue to solicit views related to the issue. In another exemplary embodiment, the system could request that the constituent provide their position on the issue in a narrative response. The best positions for each side of an issue are determined in step 225. In one exemplary embodiment, the best positions are determined by the elected official or his staff. In one exemplary embodiment, more than one position for each side of an issue can be included in the best positions and those positions can be aggregated into one or more presentations for that side of the issue.

In step 230, the best positions for each side of an issue are presented to constituents logging onto the system and the constituents are asked to vote, or select the side of the issue with which they agree. A vote is accepted on the issue by the system from constituents in step 235. In one exemplary embodiment, voting capability is limited to constituents who log into the system. In another exemplary embodiment, votes may be accepted from any person that accesses the system's webpage, irrespective of whether they logged-in. In step 240, an inquiry is conducted to determine if the constituent entering the vote on the system has been selected for special consideration. In one exemplary embodiment, a constituent may be given special consideration because they may be more affected by the issue than other constituents, may belong to a particular demographic, or may live in an area that is more greatly affected by the issue. If the constituent has not been selected for special consideration, the “NO” branch is followed to step 245, where the vote is recorded as a standard voter. The process then continues to step 260. On the other hand, if the constituent has been selected for special consideration, the “YES” branch is followed to step 250, where the vote is recorded as a special voter vote.

Additional weight, as discussed hereinabove, is given to special voter votes in step 255. In step 260, the votes for all constituents supplying a vote to the system on the issue are tallied as the standard votes plus the weighted special voter votes. In another exemplary embodiment, the system can tally the special voter votes separate from the standard votes and provide the separate vote tally to the elected officials. The vote for the logged-in constituent on the issue is recorded in a database on the system in step 265. In one exemplary embodiment, the logged-in constituent can be given the option whether he wants his vote or positions recorded or “linked” to the constituent. In an alternative embodiment, the system can provide an opt-out selection on the web page or registration web page that allows the logged-in voter to remain anonymous. The process continues from step 265 to the END step.

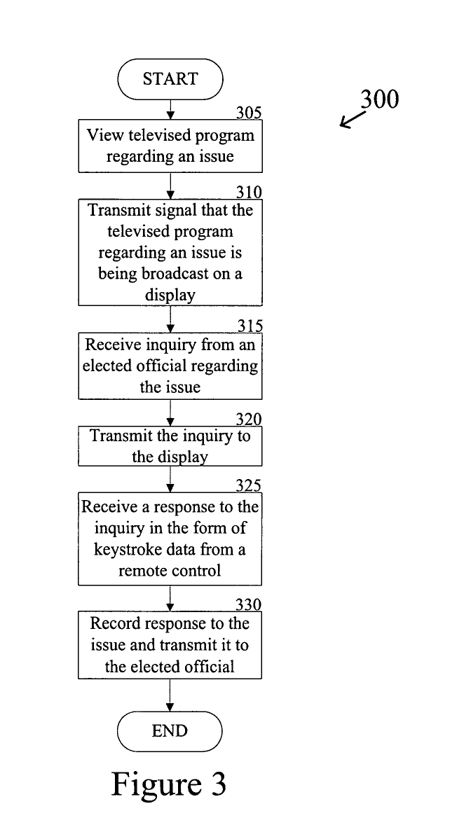

FIG. 3 is a logical flowchart diagram presented to illustrate the steps of an exemplary method 300 for interactive response to televised community issues, presented in accordance with an exemplary embodiment of the present invention. Referencing FIG. 3, the exemplary method 300 begins at the START step and continues to step 305, where a constituent views a televised program regarding an issue. For example, the constituent could be viewing C-SPAN, or some similar local version thereof, wherein the content includes debates and discussion on issues that may be brought up for a vote or decision in front of one or more elected officials. In step 310, a signal is transmitted notifying the constituent that a program regarding an issue is being broadcast on a televised program. In one exemplary embodiment, the signal can be sent by the system to some or all of the constituents logged onto the system. For example, the system may only send the signal to those constituents that reside in a particular area or belong to a particular demographic that is pertinent to the issue or from whom the elected official would like to receive comments or feedback. In an alternative embodiment, the signal could be sent to a display on a remote control to all persons who have a remote control having the capability to receive such information. In another exemplary embodiment, the signal could be transmitted to the constituents at a time prior to the broadcast.

In step 315, an inquiry regarding the issue is sent by an elected official and received by one or more constituents. In one exemplary embodiment, the inquiry can be sent by the system and received by the constituent at an Internet-accessible device or on the display of the remote control. One example of an inquiry made by an elected official includes the elected official asking what the constituent thinks of the view presented by the current person speaking on the televised program or if that speaker sways the constituent's opinion. The inquiry from the elected official is transmitted to the display of the remote control or the Internet accessible device or through the CiviConnect system in step 320. In step 325, a response to the inquiry is received from the constituent. In one exemplary embodiment, the response can be in the form of keystroke data entered into the remote control or by a response submitted through the web portal. The response to the inquiry is recorded and transmitted to the elected official making the inquiry in step 330. In one exemplary embodiment, the responses to the inquiry may also be sent to other elected officials having voting power over the issue and/or other constituents responding to the inquiry. The process then continues from step 330 to the END step.

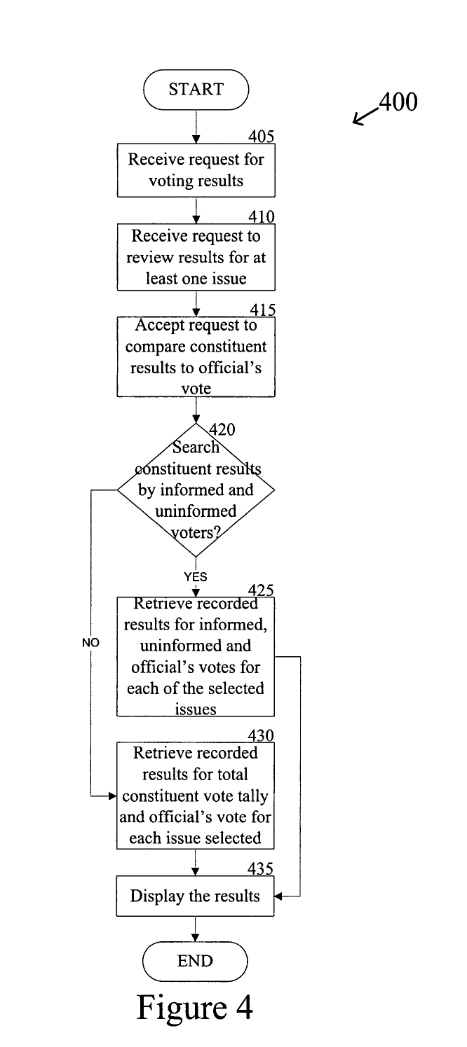

FIG. 4 is a logical flowchart diagram presented to illustrate the steps of an exemplary method 400 for retrieving and comparing voting records of an elected official to positions of his constituents, presented in accordance with an exemplary embodiment of the present invention. Now referring to FIG. 4, the exemplary method 400 begins at the START step and continues to step 405, where the system receives a request for voting results. In one exemplary embodiment, the request for voting results may be related to one or more issues and the request may be generated by an elected official or a constituent. In step 410, the system receives a request to review the voting results for at least one issue. The system accepts the request to compare the constituents' voting results entered into the system as compared to the vote registered by the elected official in step 415. In one exemplary embodiment, the voting results requested for comparison may be those of a particular elected official or all elected officials having voting power over the issues. In another exemplary embodiment, the request for a comparison of voters' votes to those of the elected officials can be sorted so that the comparison against each elected official is only against those votes originating from constituents represented by that particular elected official.

In step 420, an inquiry is conducted to determine if the constituents' results for votes on the selected issues should be searched based on informed and uninformed voters. If the search of the constituents' voting records on issues should be based on informed and uninformed voters, the “YES” branch is followed to step 425, where the system retrieves recorded results for informed and uninformed votes and the elected official's votes for each of the selected issues. The process then continues to step 435. On the other hand, if the search is not to be sorted by informed and uninformed voters, the “NO” branch is followed to step 430, where the system retrieves the total constituent vote tally and the elected official's voting record on each of the selected issues. In step 435, the constituents' vote tally and the elected official's voting record are displayed on an Internet-accessible device, on the television screen, or on the display of the remote control. The process then continues from step 435 to the END step.

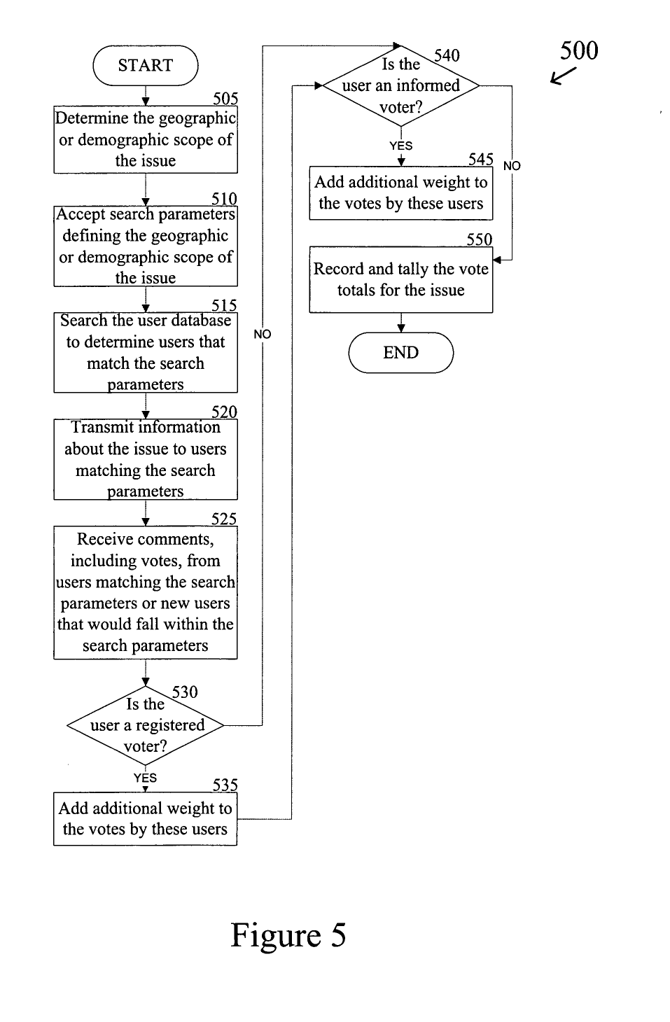

FIG. 5 is a logical flowchart diagram presented to illustrate the steps of an exemplary method 500 for selecting a subset of constituents based on a set of parameters and weighing feedback from those constituents based on another set of parameters in accordance with an exemplary embodiment of the present invention. Referencing FIG. 5, the exemplary method 500 begins at the START step and continues to step 505, where the geographic or demographic scope of an issue is determined. One example of an issue having a limited geographic effect may include an issue brought in front of a city zoning board as to whether a new condominium should be allowed at a specific address. Whether to allow the zoning variance may have a significant effect on voters in the immediate vicinity of the condominium project but may have little or no affect on constituents living in other parts of the city. In one exemplary embodiment, the determination of the parameters used to selected constituents based on geographic or demographic aspects can be made by one or more elected officials or their staff.

In step 510, the search parameters defining the geographic or demographic scope of the issue are accepted by the system. The system searches the database of constituents to determine users that match the search parameters in step 515. In one exemplary embodiment, demographic information can be provided by the constituents when they register for the system. In an alternative embodiment, the demographic information can be overlaid onto the constituents in the system based on the address or social security number they provide when registering for the system. In step 520, the system transmits information about the issue to constituents matching the search parameters. In one exemplary embodiment, the information transmitted to the constituents can include, but is not limited to, a notification of the issue, information related to the issue, scheduling information related to when the issue is to be debated or voted on by the elected officials, and requests for feedback on the issue from the constituents matching the search parameters.

In step 525, feedback and/or votes are received from constituents matching the search parameters or new users to the system who would fall within the search parameters at the system. In step 530, an inquiry is conducted to determine if the constituent on the system is a registered voter. If the constituent is a registered voter, the “YES” branch is followed to step 535, where additional weight is added to the vote of the registered voter by the system in a manner substantially similar to that described with regards to determining if the constituent is an informed voter as described hereinabove. The process then continues to step 540. Returning to the inquiry of step 530, if the constituent is not a registered voter, the “NO” branch is followed to step 540, where an inquiry is conducted to determine if the constituent is an informed voter with respect to the particular issue.

Determining if the constituent is an informed voter can be determined in the same manner as described hereinabove with regards to FIG. 1. If the constituent is an informed voter, the “YES” branch is followed to step 545, where additional weight is added to the vote of the informed voter by the system in a manner similar to that described hereinabove. In one exemplary embodiment, if the constituent is both an informed voter and a registered voter, the weight added to the vote of that constituent could be the same as if the constituent only satisfied one of the weighting criteria or the weight applied to the vote of that constituent could be greater than if the constituent had only satisfied one of the weighting criteria. While the exemplary embodiment shown in FIG. 5 describes adding additional weight to votes of constituents that satisfy certain criteria, an alternative embodiment could reduce the weight of votes for constituents that match or fail to match the selected criteria. Those of ordinary skill in the art will further recognize that another embodiment of the present invention can combine the aspects of increasing and decreasing vote weights in a number of combinations based on the criteria selected and the desires of the elected official or party setting up the parameters.

Returning to step 540, if the constituent is not an informed voter, the “NO” branch is followed to step 550. In step 550, the system records and tallies the vote totals for the issue. In the exemplary embodiment set forth in FIG. 5, the vote totals may include votes from unregistered and uninformed constituents, which would include no additional weight; registered but uninformed constituents, which would include additional weight for being a registered voter; unregistered but informed constituents, which would include additional weight for being an informed voter; and registered and informed constituents, which could include additional weight for being both a registered and informed voter. Those of ordinary skill in the art will recognize that the method could be modified to include any number and organization of parameters by which the system can weigh or determine additional information about the constituents. In addition, the method could include parameters that if satisfied, or not satisfied, could result in the vote of the constituent not being counted, irrespective of whether other parameters are met. Furthermore, while the exemplary embodiment combines the ability to select constituents based on certain demographic and geographic parameters with the ability to weigh constituent votes based on pre-selected criteria, those of ordinary skill in the art will recognize that these two facets could be separated into independent methods for receiving constituent feedback. The process continues from step 550 to the END step.

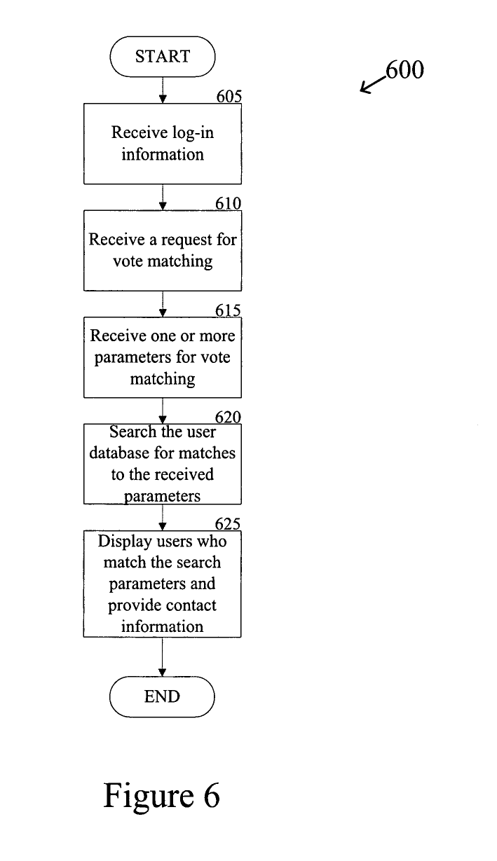

FIG. 6 is a logical flowchart diagram presented to illustrate the steps of an exemplary method 600 for searching a database for constituents with common positions on issues presented in accordance with an exemplary embodiment of the present invention. Referencing FIG. 6, the exemplary method 600 begins at the START step and continues to step 605, where the system receives log-in information, as described hereinabove in FIG. 1, from a constituent and allows the constituent access to the system. The system receives a request for vote matching from the constituent in step 610. In one exemplary embodiment, vote matching allows a constituent to insert search parameters to the system to determine constituents who vote the same as or similar to the constituent making the inquiry. In this exemplary embodiment, the determination of whether the constituents are voting the same can be based on a pre-selected or voter selected percentage of time that the inquiring voter and other voters voted the same way on an issue. In an alternative embodiment, the inquiring constituent can select a single issue and, with or without additional search parameters, determine other constituents that voted the same way as the inquiring constituent on the selected issue.

In step 615, the system receives one or more parameters for vote matching from the inquiring constituent. In one exemplary embodiment, the parameters can include, but are not limited to one or more issues, a geographic location, or one or more demographic parameters. The system searches the database of constituents who have registered on the system for matches based on the requested parameters from the inquiring constituent in step 620. In step 625, the constituents matching the search criteria are displayed. In one exemplary embodiment, the matching constituents are displayed on an Internet accessible device, television screen, or display of the remote control. In one exemplary embodiment, the information displayed can include, but is not limited to, contact information so that the inquiring constituent can contact the constituents matching the search parameters. The process continues from step 625 to the END step.

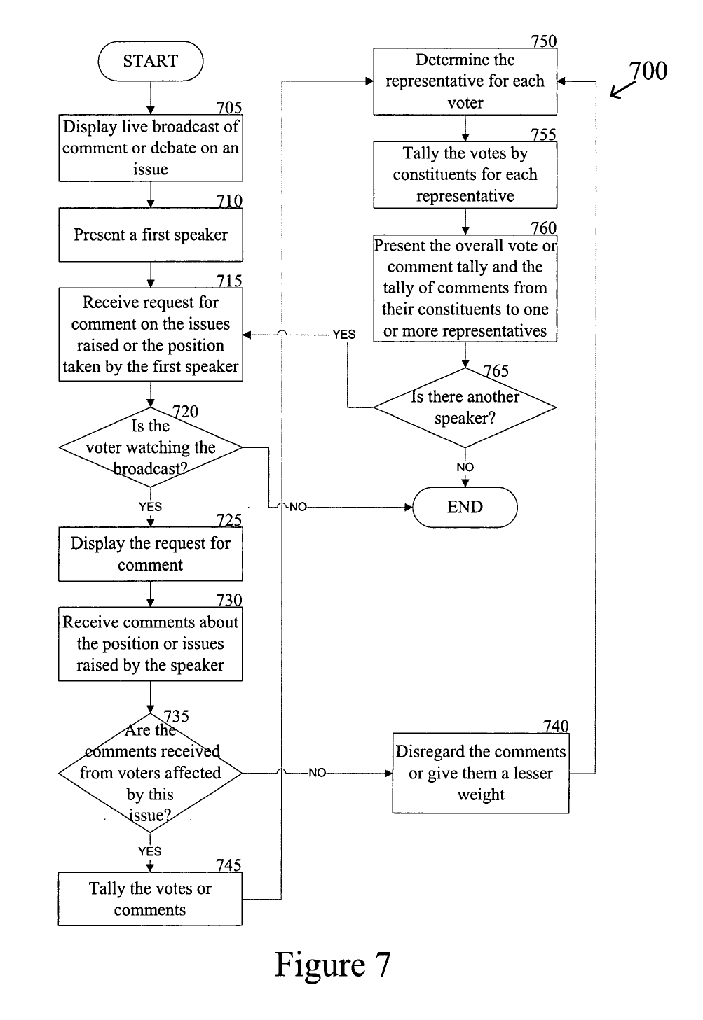

FIG. 7 is a logical flowchart diagram presented to illustrate the steps of an exemplary method 700 for receiving real-time feedback from voter constituents viewing discussion on an issue presented in accordance with an exemplary embodiment of the present invention. Now referring to FIG. 7, the exemplary method 700 begins at the START step and continues to step 705, where a live broadcast of a discussion or debate involving an issue is displayed on a television, computer, or other electronic device enabled to receive live television feeds. For example, the discussion or debate could be presented on C-SPAN, or some similar local version thereof, wherein the content includes debates and discussion on issues that may be brought up for a vote or decision in front of one or more elected officials. In step 710, a first speaker begins to speak about the issue currently being discussed or debated.

In step 715, a request is transmitted by an elected official through the system seeking comment from one of more constituents registered on the system about the issues raised or the position taken by the first speaker. In one exemplary embodiment, the request for comment can be sent by the system to some or all of the voters logged onto the system. For example, the system may only send the request to those constituents that reside in a particular area or belong to a particular demographic that is pertinent to the issue or from whom the elected official would like to receive comments or feedback. In an alternative embodiment, the request could be sent to a display on a remote control or Internet-accessible device to all persons who have a remote control having the capability to receive such information.

In step 720, an inquiry is conducted to determine if the constituent from whom comment or feedback is requested is watching the live broadcast. In one exemplary embodiment, the remote control tracks viewership or determines viewing statistics. In this embodiment, the remote control determines the channel setting, and thus the content, that its user has selected for viewing. In one embodiment, the remote control can identify the content based on the channel setting of each media device that receives signals from the MaxBox. One or more such media devices, or associated remote controls, can transmit the channel settings to the MaxBox via a radio frequency link. In one embodiment, the MaxBox functions as a tuner and records tuner commands from the media devices or the remote controls. If the constituent is not watching the live broadcast, the “NO” branch is followed to the END step. Otherwise, the “YES” branch is followed to step 725, where the system displays the request for comment on the remote control, computer, or Internet-accessible device. The system receives one or more comments from the constituents from whom feedback was requested in step 730. In step 735, an inquiry is conducted to determine if the comments being received are from constituents that are affected by this issue. For example, if the request was sent generally to all constituents registered on the system, the elected official, a member of his staff, or a third party could provide parameters related to the issue to designate those constituents who are affected by or more greatly affected by the issue. If the comments are from a constituent that is not affected by the issue, the “NO” branch is followed to step 740, where the comments are disregarded or given a lesser weight by the system than comments from affected voters. The process then continues to step 750. On the other hand, if the comments are from a voter affected by the issue, the “YES” branch is followed to step 745, where the system tallies the votes of comments from the affected constituents.

In step 750, the representative for each constituent is determined. In one exemplary embodiment, the representative for each constituent can be determined by information provided by the constituent when he registered for the system as discussed hereinabove with respect to FIG. 1. In this exemplary embodiment, “at large” candidates, those elected by the general voting populous and not a subsection thereof (for example a county commission member voted into office by the whole county instead of a subsection of the county based on geographic boundaries) may be considered a representative of all the constituents providing comments or feedback. In step 755, the system tallies the votes received from constituents and sorts them based on who there elected official is. In step 760, the system presents the overall vote or comment tally and the tally of comments from the constituent they represent to one or more of the elected officials. In step 765, an inquiry is conducted to determine if there is another speaker on the issue. If so, the “YES” branch is followed to step 715. On the other hand, if there are no additional speakers or no additional speakers that feedback is solicited for, the “NO” branch is followed from step 765 to the END step.

In conclusion, the present invention supports a method for requesting and receiving comments, feedback, or positions from constituents and providing that information to elected officials for their review while trying to determine how to vote on an issue. Furthermore, the present invention supports a method for notifying constituents or subsets of constituents about live discussions and debates on issues and soliciting feedback from the constituents on the issues presented and the speakers making comment during the discussion or debate on the issue. The present invention further supports a method for accessing a database of constituent feedback and voting history on one or more issues and determining which constituent voted the same as or different from the inquiring voter.

The present invention further supports a method for comparing an elected official's voting history on one or more issues as compared to the voting results of those constituents represented by the elected official. It will be appreciated that the present invention fulfills the needs of the prior art described herein and meets the above-stated objectives. While there have been shown and described several exemplary embodiments of the present invention, it will be evident to those or ordinary skill in the art that various modifications and changes can be made thereto without departing from the spirit and the scope of the present invention as set forth in the appended claims and equivalence thereof.

What is claimed is:

1. A method for soliciting feedback from a constituent, comprising the steps of:
soliciting a response from the constituent about an issue facing an elected official;
providing information about the issue to the constituent;
receiving the solicited response from the constituent;
determining whether the constituent reviewed the provided information; and
weighting the received response according to whether the constituent reviewed the provided information.

2. The method of claim 1, wherein the constituent is a registered voter.

3. The method of claim 1, wherein determining whether the constituent reviewed the provided information comprises the steps of:
presenting questions about the information to the constituent;
receiving second responses from the constituent to the questions;
determining if a threshold amount of the second responses are correct; and
designating the constituent as having reviewed the information based on a positive determination that the threshold amount of the second responses are correct.

4. The method of claim 1, wherein the information comprises at least one argument for each side of the issue.

5. The method of claim 4, wherein the at least one argument for each side of the issue is selected from a plurality of arguments received from other constituents.

6. The method of claim 1, further comprising the steps of:
receiving log-in information from the constituent;
presenting a display about the issue for selection by the constituent;
accepting selection of the issue from the constituent; and
accepting additional information about the issue from the constituent.

7. The method of claim 6, wherein the additional information comprises an argument for at least one side of the issue.

8. The method of claim 1, further comprising the steps of:
obtaining additional responses to the issue from a plurality of other constituents;
weighting the additional responses via applying software-implemented rules;
determining whether each additional response is for or against the issue;
summing the weighted responses for each side of the issue as a vote tally; and
displaying the vote tally.

9. The method of claim 8, further comprising the step of presenting the vote tally to the elected official.

10. The method of claim 1, wherein the response solicited is a vote on the issue.

11. The method of claim 1, wherein the step of soliciting a response from the constituent about an issue comprises transmitting the solicitation to an Internet-accessible device.

12. The method of claim 11, wherein the Internet-accessible device is a remote control.

13. The method of claim 11, wherein the Internet-accessible device comprises a personal computer.

14. The method of claim 1, further comprising the step of storing the received response on a remotely accessible server along with other responses of other constituents.

15. A method for obtaining constituent input, comprising the steps of:
transmitting signals over a communication network soliciting responses from a plurality of constituents about an issue;
receiving the solicited responses from the plurality of constituents via the communication network;
identifying a constituent of the plurality of constituents who has been selected for special consideration relative to another constituent of the plurality of constituents; and
providing greater weight to a response of the identified constituent as compared to a response of the another constituent.

16. The method of claim 15, wherein at least a portion of the plurality of constituents are registered voters.

17. The method of claim 15, wherein the step of identifying a constituent comprises the steps of:
receiving at least one parameter related to the plurality of constituents;
searching a constituent database to determine constituents meeting the at least one parameter; and
designating the identified constituent as being selected for special consideration based on a positive determination that the identified constituent meets the at least one parameter.

18. The method of claim 17, wherein the at least one parameter comprises a demographic criterion.

19. The method of claim 17, wherein the at least one parameter describes a geographic area.

20. The method of claim 15, further comprising the steps of:
receiving log-in information from the plurality of constituents;
presenting a display relating to the issue for selection by the constituent; and
accepting issue selections from the constituents.

21. The method of claim 15, wherein the step of providing greater weight comprises weighting each of the received responses according to a criterion, and wherein the method further comprises the steps of:
determining whether each of the received responses is for or against the issue;
summing the weighted responses for each side of the issue; and
displaying summation results to at least one elected official.

22. The method of claim 15, wherein the response solicited comprises a vote on the issue.

23. The method of claim 15, wherein soliciting responses from the plurality of constituents comprises transmitting solicitations electronically to Internet-accessible devices.

24. The method of claim 23, wherein each of the Internet-accessible devices is a remote control.

25. The method of claim 15, further comprising the step of storing the received responses on a computer-based storage medium.

26. A method for constituent interaction, comprising the steps of:
transmitting a notification to an Internet-accessible device of a constituent, the notification informing the constituent of a broadcast discussion about an issue;
receiving a response to the notification from the Internet-accessible device; and
transmitting the received response to at least one elected official.

27. The method of claim 26, wherein the broadcast discussion comprises a live discussion, and wherein the method further comprises the steps of:
providing a speaker to discuss the issue, wherein the speaker presents an opinion on the issue; and
soliciting feedback on the presented opinion from the constituent and a plurality of other constituents.

28. The method of claim 27, wherein the solicited feedback comprises an indication regarding whether each of the constituent and the plurality of other constituents agrees with the opinion.

29. The method of claim 26, wherein the Internet-accessible device comprises a remote control.

30. The method of claim 29, wherein the remote control comprises a display for presenting video and audio content.

31. The method of claim 26, further comprising the steps of:
determining if the constituent is watching the broadcast discussion; and
in response to a positive determination that the constituent is watching the broadcast, transmitting a request for input from the constituent regarding the issue.

32. The method of claim 31, wherein determining if a constituent is watching the broadcast of the issue comprises evaluating information stored in the Internet-accessible device.

33. The method of claim 26, wherein the step of transmitting the received response to at least one elected official comprises the steps of:
determining whether the constituent is affected by the issue;
in response to a positive determination that the constituent is affected by the issue, tallying the received response; and
in response to a negative determination that the constituent is affected by the issue, disregarding the received response;

34. The method of claim 33, further comprising the steps of:
receiving and storing a vote of the elected official on the issue;
receiving and storing another vote of another elected official on the issue; and
presenting on a display of the Internet-accessible device a comparison between the vote of the elected official and the another vote of the another elected official.

35. The method of claim 26, wherein the notification comprises a request for input from the constituent regarding the issue.

36. A method for interacting with constituents, comprising the steps of:
receiving responses from the constituents in response to transmitting requests for constituent input via a communication network;
receiving a parameter related to the constituents;
in response to applying the received parameter to a constituent database, categorizing the constituents into a first plurality of constituents complying with the received parameter and a second plurality of constituents deviating from the received parameter;
associating each of the received responses with one of the first plurality of constituents and the second plurality of constituents; and
weighting the received responses associated with the first plurality of constituents more heavily than the received responses associated with the second plurality of constituents.

37. The method of claim 36, wherein categorizing the constituents comprises determining whether each of the constituents is a registered voter.

38. The method of claim 36, wherein categorizing the constituents comprises determining if each of the constituents is an informed voter.

39. The method of claim 38, wherein determining if each of the constituents is an informed voter comprises the steps of:
providing supplemental information about an issue to the constituents; and
determining whether each of the constituents reviewed the supplemental information,
wherein the first plurality of constituents are determined to have reviewed the supplemental information more thoroughly than the second plurality of constituents.

40. The method of claim 39, wherein determining whether each of the constituents reviewed the supplemental information comprises the steps of:
presenting questions about the supplemental information to each of the constituents;
receiving replies from the constituents to the presented questions;
determining if each of the received replies is correct; and
determining whether each of the constituents has submitted a threshold number of correct replies.

41. The method of claim 39, wherein the supplemental information comprises at least one argument for each side of the issue.

42. The method of claim 41, wherein the at least one argument for each side of an issue is selected from a plurality of arguments selectively received from the first plurality of constituents.

43. The method of claim 36, wherein the step of receiving the parameter comprises receiving an Internet transmission from an elected official.

44. The method of claim 36, further comprising the step of recording the received responses for each of the constituents.

45. The method of claim 36, wherein the weighting step comprises:
the received responses associated with the first plurality of constituents influencing a vote of an elected official; and
disregarding the received responses associated with the second plurality of constituents.
